(19) United States
(12) Patent Application Publication
(10) Pub. No.: US 2013/0174810 A1
(43) Pub. Date: Jul. 11, 2013

(54) FUEL INJECTOR BRACKET ASSEMBLY

(71) Applicants: Kenneth R. Levey, West Chicago, IL (US); Jason D. Holt, St. Charles, IL (US); Robert R. Schaser, Hampshire, IL (US); Eric B. Jipp, Chicago, IL (US); Jeremy R.D. Tuttle, Dearborn, MI (US)

(72) Inventors: Kenneth R. Levey, West Chicago, IL (US); Jason D. Holt, St. Charles, IL (US); Robert R. Schaser, Hampshire, IL (US); Eric B. Jipp, Chicago, IL (US); Jeremy R.D. Tuttle, Dearborn, MI (US)

(73) Assignee: Illinois Tool Works Inc., Glenview, IL (US)

(21) Appl. No.: 13/876,011

(22) PCT Filed: Oct. 19, 2011
(86) PCT No.: PCT/US11/56883

§ 371 Date: Mar. 26, 2013

Related U.S. Application Data
(60) Provisional application No. 61/394,993, filed on Oct. 20, 2010.

(51) Int. Cl. F02M 69/04

(52) U.S. Cl. CPC F02M 69/04
USPC 123/470

(57) ABSTRACT

A bracket assembly is configured to secure a fuel injector to a mounting frame within a vehicle. The bracket assembly includes a single unitary main body formed from a single piece of stamped material. The main body includes a nozzle-engaging member configured to securely retain a nozzle of the fuel injector, and a fastener-engaging member configured to retain a fastener that secures the single unitary main body to the mounting frame.

### RELATED APPLICATIONS

This application relates to and claims priority benefits from U.S. Provisional Patent Application No. 61/394,993 entitled “Fuel Injector Bracket,” filed Oct. 20, 2011, which is hereby incorporated by reference in its entirety.

### FIELD OF EMBODIMENTS OF THE INVENTION

Embodiments of the present invention generally relate to a system and method of securing a fuel injector in position.

### BACKGROUND

Various vehicles, such as automobiles, are equipped with fuel injector systems. A fuel injector system is configured to mix fuel with air in an internal combustion engine. In general, a fuel injection system atomizes fuel, such as gasoline, by pumping the fuel through a nozzle under high pressure. Typically, a fuel injector system includes a nozzle operatively connected to a valve and a pump or other such device that injects the fuel through the valve and nozzle.

A fuel injector system is secured within a vehicle. For example, a clamp may be used to secure the fuel injector to a rigid frame within a vehicle.

FIG. 1 illustrates an isometric view of a conventional cast fuel injector clamp 10 securing a fuel injector 12 to a mounting frame 14 of a vehicle. The clamp 10 includes a bulky main body 16. The clamp 10 is typically a solid, bulky piece of cast metal. The clamp 10 is formed through a process that includes surface trimming, machining, and concentric hole formation. That is, the process of forming a typical cast clamp 10 typically requires secondary finishing operations to trim surfaces, machine flats, and create concentric holes.

As shown in FIG. 1, the main body 16 includes a collar 18 extending upwardly therefrom. The collar 18 defines a central passage (not shown) that passes through the main body 16. The clamp-forming process requires the step of forming the passage through the main body 16. The passage is configured to allow a bolt 20 to pass therethrough in order to securely fasten the clamp 10 to the mounting frame 14.

As shown in FIG. 1, the clamp 10 abuts the mounting frame 14 at pivot point 22. In order to secure the end of the clamp 10 to the mounting frame 14, a securing pin or the like is typically used at the pivot point 22. The clamp also abuts a ledge 23 of the fuel injector 12 at pivot point 24. As such, the clamp 10 pivots on the pivot points 22 and 24 in order to account for dimensional variances. In this manner, however, the clamp 10 is supported above the mounting frame 14 and the ledge 23 at these two pivot points 22 and 24. Consequently, the bolt 20 may fatigue over time and/or loosen, thereby causing vibrations. Overall, the clamp 10 may not securely connect the fuel injector 12 to the mounting frame over a long period of time.

### SUMMARY OF EMBODIMENTS OF THE INVENTION

Certain embodiments of the present invention provide a bracket assembly configured to secure a fuel injector to a mounting frame within a vehicle. The assembly includes a single unitary main body formed from a single piece of stamped material. The main body includes a nozzle-engaging member configured to securely retain a nozzle of the fuel injector, and a fastener-engaging member configured to retain a fastener that secures the single unitary main body to the mounting frame.

The single unitary main body may include at least one truss and may further include a folded end integrally connected to first and second truss fins. The first and second truss fins mirror one another. The first and second truss fins may be securely fastened together. For example, the first and second truss fins may be bonded together.

The fastener-engaging member may include a first outwardly-bowed wall integrally connected to the first truss fin, and a second outwardly-bowed wall integrally connected to the second truss fin. The first and second outwardly-bowed walls define a fastener passage therebetween.

The nozzle-engaging member may include first and second nozzle-engaging prongs defining a nozzle-engaging area therebetween.

The assembly may also include a pre-captured fastener secured to the main body by the fastener-engaging member. The main body is formed with the pre-captured fastener.

The main body may include a truss base having extension arms integrally connected to curved support beams through folded ends. A nozzle-engaging area is defined between the extension arms and the curved support beams. The truss base is configured to lie flat along an upper surface of the mounting frame. The main body may be devoid of a securing pin configured to secure the main body to the mounting frame.

A planar wall may integrally connect to the curved support beams. A trailing beam integrally connects to the planar wall. The trailing beam abuts into an end of the truss base.

Additionally, a drawn compression limiter may be positioned between the planar wall and the truss base.

Certain embodiments of the present invention provide a bracket assembly configured to secure a fuel injector to a mounting frame within a vehicle. The bracket assembly includes a single unitary main body formed from a single piece of stamped material.

The single unitary main body may include a folded end integrally connected to first and second truss fins, wherein the first and second truss fins minor one another.

The single unitary main body may also include a first outwardly-bowed wall integrally connected to the first truss fin, and a second outwardly-bowed wall integrally connected to the second truss fin. The first and second outwardly-bowed walls define a fastener passage therebetween.

The single unitary main body may also include a first nozzle-engaging prong integrally connected to the first outwardly-bowed wall, and a second nozzle-engaging prong integrally connected to the second outwardly-bowed wall. The first and second nozzle-engaging prongs define a nozzle-engaging area therebetween.

The single unitary main body is symmetrical about a longitudinal axis that bisects the folded end.

Certain embodiments of the present invention provide a bracket assembly configured to secure a fuel injector to a mounting frame within a vehicle. The bracket assembly includes a single unitary main body formed from a single piece of stamped material.

The single unitary main body may include a truss base having extension arms integrally connected to curved, flexible support beams through folded ends. A nozzle-engaging area is defined between the extension arms and the curved, flexible support beams. The truss base is configured to lie flat along an upper surface of the mounting frame.

The single unitary main body may also include a planar wall integrally connected to the curved, flexible support beams. The planar wall and the truss base are located on different planes.

The single unitary main body may also include a trailing beam integrally connected to the planar wall. The trailing beam abuts into an end of the truss base.

### BRIEF DESCRIPTION OF SEVERAL VIEWS OF THE DRAWINGS

FIG. 1 illustrates an isometric view of a conventional cast fuel injector clamp securing a fuel injector to a mounting frame of a vehicle.

FIG. 2 illustrates an isometric top view of a fuel injector bracket, according to an embodiment of the present invention.

FIG. 3 illustrates an isometric top view of a fuel injector bracket securely engaging a fastener, according to an embodiment of the present invention.

FIG. 4 illustrates a lateral view of a fuel injector bracket securing a fuel injector to a mounting frame, according to an embodiment of the present invention.

FIG. 5 illustrates an isometric view of a fuel injector bracket securely engaging a fastener, according to an embodiment of the present invention.

FIG. 6 illustrates a lateral view of a fuel injector bracket securing a fuel injector to a mounting frame, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

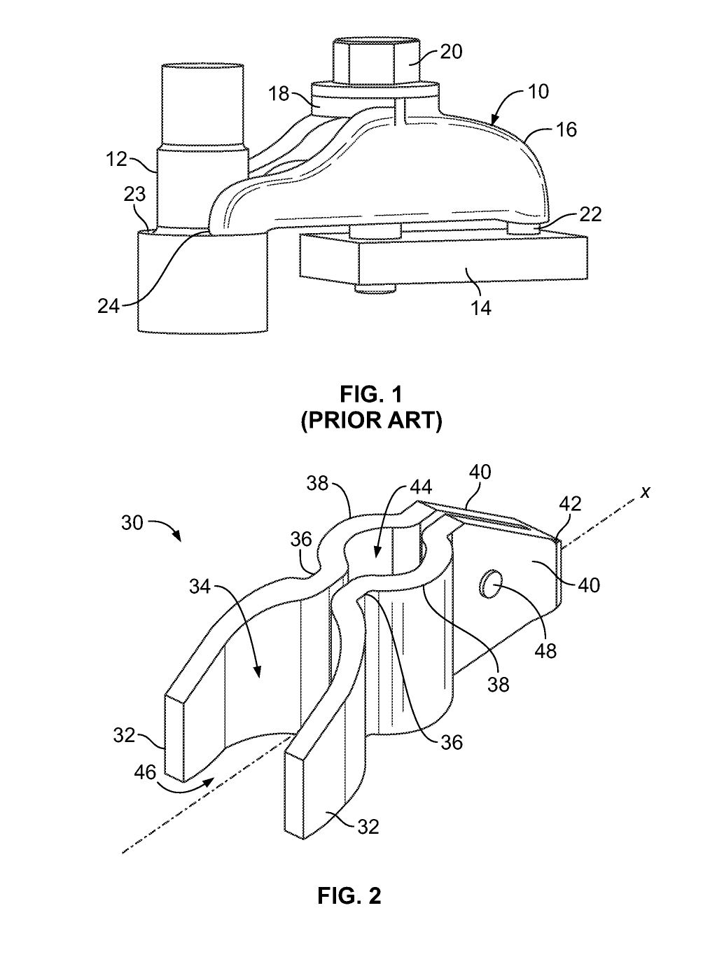

FIG. 2 illustrates an isometric top view of a fuel injector bracket 30, according to an embodiment of the present invention. Unlike the clamp 10 (shown in FIG. 1), the bracket 30 may be formed of a single sheet of metal. The sheet is then crimped, bent, and otherwise formed to yield the bracket 30.

The bracket 30 includes nozzle-engaging prongs 32 that are bent and formed to receive and retain a nozzle of a fuel injector (not shown in FIG. 1). The prongs 32 define a nozzle-engaging area 34 therebetween.

Each prong 32 curves inwardly toward a center of the clamp and integrally connects to a leading crimped wall 36. Each leading crimped wall 36, in turn, integrally connects to an outwardly-bowed wall 38 that curves back toward a center line x into a trailing truss fin 40. The trailing fins 40 are connected by an integral folded end 42 that is generally perpendicular to the trailing fins 40. In general, the single sheet of metal that forms the clamp 10 is folded about the end 42 to form the symmetrical clamp 10.

Once folded about the end 42, the symmetrical outwardly-bowed walls 38 define a fastener passage 44 configured to receive and retain a fastener, such as a bolt. Similarly, the symmetrical prongs 32 define the nozzle-engaging area 34 having an open end 46 into which a nozzle of a fuel injector passes.

Additionally, the fins 40 may be secured together to prevent the bracket 30 from spreading open. For example, the fins 40 may be bonded together. A fastener or tab 48 may be used to fasten the fins 40 together.

Unlike the clamp 10 (shown in FIG. 1), the clamp 30 is formed of a single, lightweight, stamped piece of aluminum, for example. The bracket 30 is symmetrical about the folded end 42 and the center line x.

Additionally, unlike the clamp 10, the bracket 30 is formed entirely during the stamping process with flattened mounting surface and trimmed surface contact areas meeting tolerance requirements, thereby eliminating complex cast processing and expensive secondary operations to finish mounting surfaces and through-holes.

Additionally, the vertically-folded (about the vertical folded end 42) thin metal design with trimmed truss shape provides rigidity and strength. Therefore, the bracket 30 has less material than the clamp 10, thereby making the bracket 30 lighter, while at the same time providing increased strength and durability.

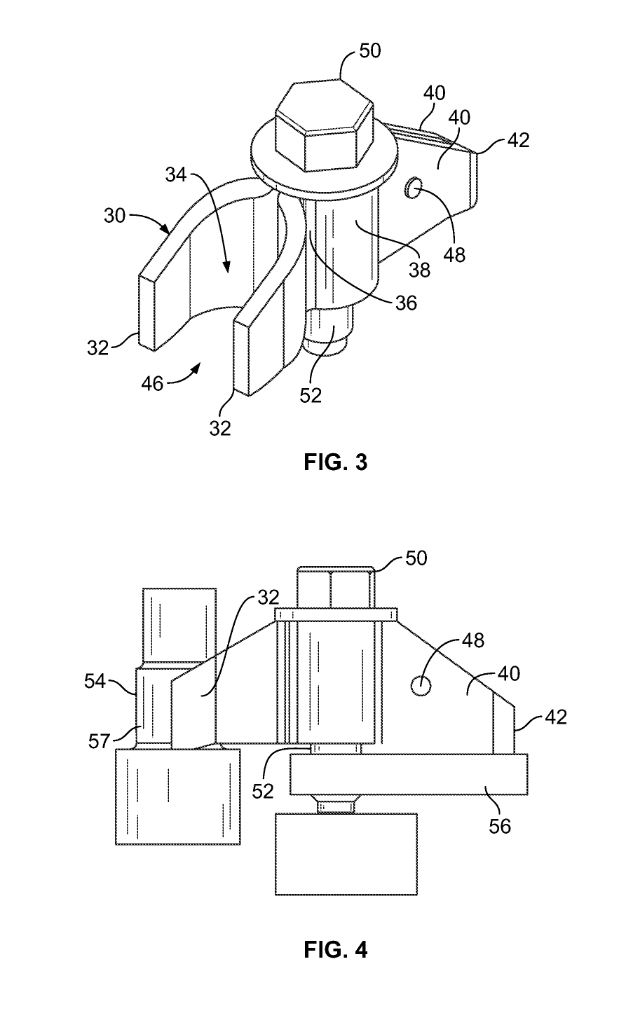

FIG. 3 illustrates an isometric top view of the fuel injector bracket 30 securely engaging a fastener 50, such as a bolt and washer, according to an embodiment of the present invention. The fastener 50 is securely retained within the fastener passage 44 (shown in FIG. 2). Indeed, the formed passage 44 defined by the outwardly-bowed walls 38 allows for the use of a pre-captured fastener 50, thereby eliminating the need for a separate fastener to be procured (such as with the clamp 10, shown in FIG. 1). For example, a fastener tube 52 into which the fastener 50 is positioned may be cradled between the outwardly-bowed walls 38 during the manufacturing process. This feature eliminates the need for line installation of loose bolts during the manufacturing process.

FIG. 4 illustrates a lateral view of the fuel injector bracket 30 securing a fuel injector 54 to a mounting frame 56, according to an embodiment of the present invention. A nozzle 57 of the fuel injector 54 is secured between the prongs 32. As shown in FIG. 4, for example, the prongs 32 and fins 40 define a truss shape. The truss shape has less material, while providing increased strength, as compared to the conventional clamp 10 (shown in FIG. 1).

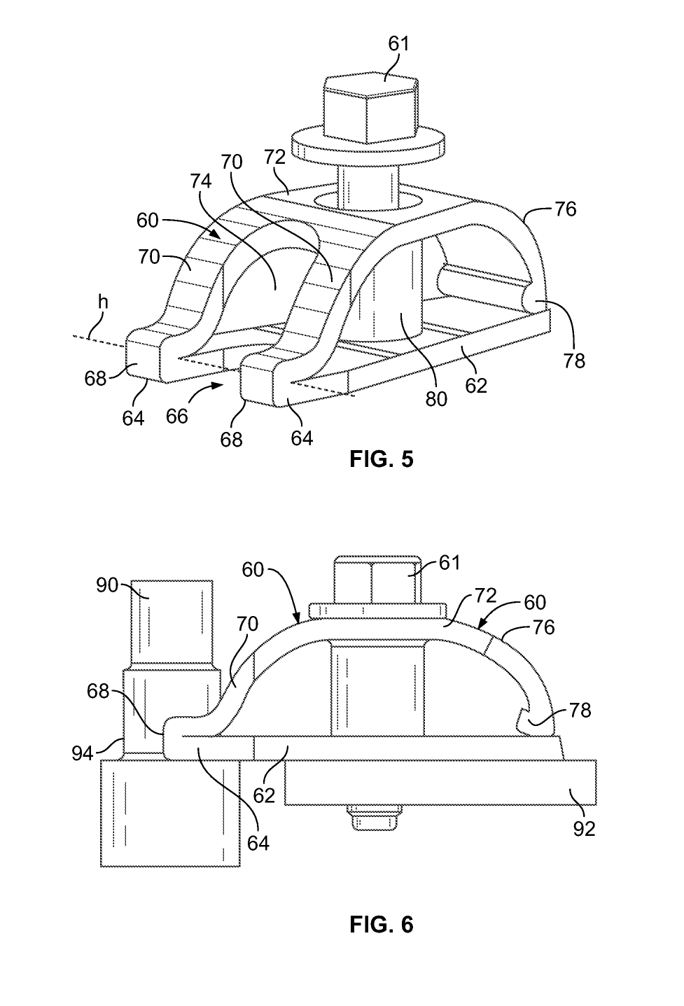

FIG. 5 illustrates an isometric view of a fuel injector bracket 60 securely engaging a fastener 61, according to an embodiment of the present invention. Like the bracket 30, the bracket 60 is also formed of a single piece of stamped material.

The bracket 60 includes a planar truss base 62 having lateral arms 64 separated by an interior gap 66. Each arm 64 is integrally connected to an upward fold 68 about a horizontal (as shown in FIG. 5) axis h. In turn, each fold 68 integrally connects to an upper support beam 70 that upwardly curves over the base 62 and integrally connects to a flattened upper wall 72, thereby forming an upper truss. As shown in FIG. 5, the support beams 70 are also separated by a gap 74.

The flattened upper wall 72 integrally connects to a trailing beam 76 that curves downwardly to an end of the truss base 62. The end of the trailing beam 76 includes an expanded studded tail 78 that rests on the end of the truss base 62.

A fastener hole is formed through the upper wall 72 and connects to a drawn cylindrical compression limiter 80 that extends between the upper wall 72 and the truss base 62 (a fastener hole is also formed through the truss base 62 underneath the compression limiter 80). The pre-captured fastener 61 is retained within the fastener holes and compression limiter 80.

The curved truss design defined by the support beams 70 and the trailing beam 76 provides a flexible bracket 60 that is able to mate to surfaces having height variances. The drawn compression limiter 80 transfers load from the top truss wall 72 to the truss base 62 during clamping.

FIG. 6 illustrates a lateral view of the fuel injector bracket 60 securing a fuel injector 90 to a mounting frame 92, according to an embodiment of the present invention. Referring to FIGS. 5 and 6, a nozzle 94 of the fuel injector 90 is secured between ends of the opposing arms 64 and opposing support beams 70. That is, the nozzle 94 is securely positioned within the interior gaps 66 and 74 defined between the arms 64 and support beams 70, respectively.

Additionally, because the bracket 60 includes a flexible truss design (for example, the flexible, curved support beams 70), the bracket 60 may flex with respect to the mounting frame 92 and the fuel injector 90. Therefore, the generally-flat base 62 overlays a substantial length of the mounting surface 92. Accordingly, the built-in compliance (through the flexible truss design) distributes load over a large surface area of the mounting frame, thereby eliminating the need for an inserted pin that secures an end of the bracket 60 to the mounting surface.

Similar to the bracket 30, the bracket 60 may be formed entirely during a stamping process.

During the clamping process, the bracket 60 provides a positive clamp over a full range of stacking heights. This is in stark contrast to the clamp 10 (shown in FIG. 1), which typically requires a hardened pin to be installed so a curved surface thereof does not brinell into the aluminum mounting surface when the fuel injector is titled on an angle.

Thus, embodiments of the present invention provide fuel injector bracket assemblies that may be formed of a single piece of stamped material, such as aluminum. Embodiments of the present invention provide bracket assemblies that are lighter, stronger, and more reliable than the clamp 10 (shown in FIG. 1).

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A bracket assembly configured to secure a fuel injector to a mounting frame within a vehicle, the bracket assembly comprising:
a single unitary main body formed from a single piece of stamped material, said single unitary main body including a nozzle-engaging member configured to securely retain a nozzle of the fuel injector, and a fastener-engaging member configured to retain a fastener that secures the single unitary main body to the mounting frame.

2. The bracket assembly of claim 1, wherein said single unitary main body further includes a folded end integrally connected to first and second truss fins, wherein said first and second truss fins mirror one another.

3. The bracket assembly of claim 2, wherein said first and second truss fins are securely fastened together.

4. The bracket assembly of claim 3, wherein said first and second truss fins are bonded together.

5. The bracket assembly of claim 2, wherein said fastener-engaging member comprises a first outwardly-bowed wall integrally connected to said first truss fin, and a second outwardly-bowed wall integrally connected to said second truss fin, wherein said first and second outwardly-bowed walls define a fastener passage therebetween.

6. The bracket assembly of claim 1, wherein said nozzle-engaging member comprises first and second nozzle-engaging prongs defining a nozzle-engaging area therebetween.

7. The bracket assembly of claim 1, further comprising a pre-captured fastener secured to said main body by said fastener-engaging member, wherein said main body is formed with said pre-captured fastener.

8. The bracket assembly of claim 1, wherein said main body comprises at least one truss.

9. The bracket assembly of claim 1, wherein said main body comprises a truss base having extension arms integrally connected to curved support beams through folded ends, wherein a nozzle-engaging area is defined between said extension arms and said curved support beams.

10. The bracket assembly of claim 9, wherein said truss base is configured to lie flat along an upper surface of the mounting frame.

11. The bracket assembly of claim 9, wherein said main body is devoid of a securing pin configured to secure said main body to the mounting frame.

12. The bracket assembly of claim 9, wherein a planar wall integrally connects to said curved support beams, wherein a trailing beam integrally connects to said planar wall, and wherein said trailing beam abuts into an end of said truss base.

13. The bracket assembly of claim 9, further comprising a drawn compression limiter positioned between said planar wall and said truss base.

14. A bracket assembly configured to secure a fuel injector to a mounting frame within a vehicle, the bracket assembly comprising:
a single unitary main body formed from a single piece of stamped material, said single unitary main body including:
a folded end integrally connected to first and second truss fins, wherein said first and second truss fins mirror one another;
a first outwardly-bowed wall integrally connected to said first truss fin, and a second outwardly-bowed wall integrally connected to said second truss fin, wherein said first and second outwardly-bowed walls define a fastener passage therebetween; and
a first nozzle-engaging prong integrally connected to said first outwardly-bowed wall, and a second nozzle-engaging prong integrally connected to said second outwardly-bowed wall, wherein said first and second nozzle-engaging prongs defining a nozzle-engaging area therebetween,
wherein said single unitary main body is symmetrical about a longitudinal axis that bisects said folded end.

15. The bracket assembly of claim 14, wherein said first and second truss fins are securely fastened together to prevent said main body from spreading apart.

16. The bracket assembly of claim 15, wherein said first and second truss fins are bonded together.

17. The bracket assembly of claim 14, further comprising a pre-captured fastener secured within said fastener passage, wherein said main body is formed with said pre-captured fastener.

18. A bracket assembly configured to secure a fuel injector to a mounting frame within a vehicle, the bracket assembly comprising:
a single unitary main body formed from a single piece of stamped material, said single unitary main body including:
a truss base having extension arms integrally connected to curved, flexible support beams through folded ends, wherein a nozzle-engaging area is defined between said extension arms and said curved, flexible support beams, wherein said truss base is configured to lie flat along an upper surface of the mounting frame;
a planar wall integrally connected to said curved, flexible support beams, wherein said planar wall and said truss base are located on different planes; and
a trailing beam integrally connected to said planar wall, and wherein said trailing beam abuts into an end of said truss base.

19. The bracket assembly of claim 18, wherein said main body is devoid of a securing pin configured to secure said main body to the mounting frame.

20. The bracket assembly of claim 18, further comprising a drawn compression limiter positioned between said planar wall and said truss base.
